(19) United States
(12) Patent Application Publication
(10) Pub. No.: US 2007/0061154 A1
(43) Pub. Date: Mar. 15, 2007

(54) Product data exchange

(75) Inventors: Jan Albert Markvoort, Eindhoven (NL); Silvan Johan Henri Willem Wiegeraad, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/578,653

(22) PCT Filed: Nov. 4, 2004
(86) PCT No.: PCT/IB04/52311

§ 371 Date: May 9, 2006

(30) Foreign Application Priority Data
Nov. 14, 2003 (EP) 03104196.5

(51) Int. Cl. G06Q 99/00

(52) U.S. Cl. 705/1

(57) ABSTRACT

A product data exchange system 300 is used for exchanging technical product data between respective computer systems (310, 320, 340, 350, 360) of a plurality of collaborating companies. At least a computer system (310) of a first one of the collaborating companies includes a plurality of distinct data management systems (312, 314, 316), such as CAD, PLM, ERP, each for creating respective technical product data. The system (310) also includes an editing system (318) for importing technical product data relating to a userselectable project from a plurality of the data management systems, creating an exchange package representing user-selectable parts of the imported technical product data; and providing the exchange package to a computer system located at at least one of the other collaborating companies.

### FIELD OF THE INVENTION

The invention relates to a product data exchange system for exchanging technical product data between respective computer systems of a plurality of collaborating companies. The invention further relates to a method of exchanging technical product data between the collaborating companies.

### BACKGROUND OF THE INVENTION

Many product supplying companies operate in a global network with customers, co-developers, suppliers, contract manufacturers, subcontractors, service companies, etc. Each of those companies may again have co-developers, suppliers, subcontractors, etc. For example, production and servicing of a consumer electronics device may involve several companies for:
the design of the overall device,
development of electrical components, software modules, ICs, and mechanical components,
manufacturing/supplying of the electrical components, the software modules, the ICs, the mechanical components, and modules;
assembly of the final device; and
maintenance/servicing of the device.

During the lifecycle of a product, the availability of the corresponding technical product data in the right versions, on the right location, to the right person, and in the right format is essential for the business. Internally, most companies use various data management systems to manage product data and the related processes to distribute this information across their own development and manufacturing sites. Examples of such systems are Computer Aided Design/Engineering (CAD/CAE/CASE) systems (e.g. Unigraphics, Pro/Engineer, AutoCAD, Catia, Mentor Graphics, Cadence, Ansys, Continuus, Telelogic Synergy and ClearCase); Product Data Management/Product Lifecycle Management (PDM/PLM) systems (e.g. Metaphase, EDS TeamCenter, eMatrix, PTC WindChill, SAP/PLM, IBM Dassault Enovia); and Enterprise Resource Planning/Customer Relationship Management/Component- and Supplier Management/Supply Chain Management (ERP/CRM/CSM/SCM) systems (e.g. BaaN, SAP, PeopleSoft, Aspect). However, to facilitate the collaborative development and supply chain communication with external partners (and sometimes also internal partners), the distribution and exchange of technical product data is needed. The technical product data preferably includes all technical disciplines (e.g. software, mechanics, electronics) and covers the entire product lifecycle (i.e. from conceptual design to product obsolescence). For the exchange of operational data between companies (e.g. pricing, ordering, invoicing and payment information) e-commerce and b2b-commerce standards have been developed.

For the exchange of technical product data the Nemi/IPC Product Data eXchange (PDX) standard for electronics manufacturing supply chain communication, IPC-257-Series, have been developed by the Nemi (National Electronics Manufacturing Initiative, www.nemi.org) and IPC (Association Connecting Electronic Industries, www.ipc.org). This standard focuses on the manufacturing supply chain communication between Original Equipment Manufacturers, Electronics Manufacturing Services and component suppliers in the electronics field. The standard is intended for direct data exchange between data management systems that comply with the standard (a distributed approach). No provisions exist for use of non-compliant systems or no system at all.

A centralized approach is known from the SAP Collaborative Engineering and Project management application (CEP) designed to facilitate engineering and project management efforts of dispersed groups. CEP is a collaborative environment in which the responsible company (initiator) collects project relevant information, using the SAP-backbone and publishes the information for access by business partners. It gives the partners via a web-browser (on-line) access to the project info stored in the CEP application. By means of a web-browser the partners can log-in to the CEP system, view and retrieve the information that has been published for them by the initiator to them. For downloading the assigned information, participants select a folder and download its contents to their local PC. The CEP work area allows navigation and access to folder information such as bills of material, project plans and related documents. Partners can make off-line modifications to the downloaded information and upload the configuration folder with the modifications to the ITS server of the owner. At the initiator (owner) site there exist a tight integration of the CEP environment into owner's SAP suite of change and lifecycle management applications. The data structures and working methods in CEP are based on the SAP system of the owner. The CEP system allows external partner to work in (a part of) the owner's SAP system. It provides no solution to couple other systems (or other SAP databases) to the SAP system of the owner, or to facilitate data exchange between multiple systems. The CEP system thus forces partners to work with data structures and working methods of SAP system of the owner. This is problematic because the data structures and working methods will not match with the partners' own PDM environments.

### SUMMARY OF THE INVENTION

It is an object of the invention to provide a system and method for exchanging technical product data that is more open.

To meet the object of the invention, at least a computer system of a first one of the collaborating companies includes:

a plurality of distinct data management systems, such as CAD, PLM, ERP, each for creating respective technical product data; and

an editing system for:
importing technical product data relating to a user-selectable project from a plurality of the data management systems;
creating an exchange package representing user-selectable parts of the imported technical product data; and
providing the exchange package to a computer system located at at least one of the other collaborating companies.

The editing system enables a company to keep on using distinct data management systems and combine all relevant technical product data into one exchange package and provide that package to the partners. The data management systems need not be of one make and also need not to comply with one standard. Optimized data management systems may be used. The data management systems may, for example, be optimized for the task (e.g. design mechanical parts or design of software) or optimized in price/performance/functionality for the company (e.g. a full-blown distributed system for multinationals and a simple stand-alone system for a small company in a developing country). The data management system may even be proprietary. The exchange package may be provided in any suitable way. In general, the package may be relatively large, for example between 1 and 500 Mbytes large, since some technical data files (e.g. CAD files) by nature are large. The package is, therefore, preferably provided using off-line electronic file transfer or on a record carrier, such as a CD-ROM. The package is transferred in its entirety. The elements of the package need not to be selected and downloaded individually, in an on-line manner.

According to the measure of the dependent claim 2, a computer system of at least one of the collaborating companies includes:

a further data management system for operating on technical product data; and

a second editing system for:
retrieving the exchange package; and
exporting user-selectable technical product data from the exchange package to the further data management system.

In this way, the company that receives the package can keep on using its own data management system. The editor enables a user to retrieve those parts of the package that are relevant for the company and can be imported by its data management system.

According to the measure of the dependent claim 3, a computer system of at least one of the collaborating companies includes a third editing system for:

retrieving the exchange package;

combining user-selectable parts of technical product data in the retrieved exchange package into a further exchange package; and

providing the further exchange package to a computer system located at at least one sub-contractor of the collaborating company.

In this way, a ‘hierarchy’ of collaborating companies can be formed. For example, a supplier of a module may outsource development/supply of parts of the module. The editor enables a company to select only those parts relevant for its suppliers.

According to the measure of the dependent claim 4, the editing system enables a user to perform at least one of the following operations:
add technical product data into the exchange package;
remove a user-selectable part of the imported technical product data;
modify a user-selectable part of the imported technical product data.

According to the measure of the dependent claim 5, the editing system is operative to automatically insert traceability data into the exchange package representative of control operations of a user of the system. Since the user of the editing system selects data from different sources, the user as such adds knowledge. The operations of the user are recorded in the package, so that at a later moment it can be established why certain data is or is not in the package.

According to the measure of the dependent claim 6, the traceability data includes:
for added technical products data: a representation of the added technical product data;
for removed technical product data: a representation of the removed technical product data; and
for modified technical product data: a representation of both the original and modified technical product data. In this way, the package is self-contained. No other sources need to be consulted to have all relevant technical product data for the project. Traceability data may be incorporated in the package in any suitable way, e.g. by fully copying original and modified data. Alternatively, only changes may be indicated.

According to the measure of the dependent claim 7, the editing system is operative to import technical product data that relates to a same baseline of the project from the plurality of the data management systems. In this context with baseline is meant a consistent and complete set of technical product data, relating to a same version/revision of the data, that the receiving company needs to perform a task that has been assigned to him. Preferably, the exchange package exclusively contains data relating to one baseline to avoid that a receiver of the package gets confused on what which version/revision is the proper one to use. The baseline approach also limits the number of times that product data has to be exchanged during a certain collaboration activity, since an updated version of a file is not exchanged as no new overall baseline status has been reached. It also avoids the risk that a company works on documents from different partners that, although in itself correct, actually should not be used in combination, since they relate to different versions and may be incompatible.

According to the measure of the dependent claim 8, a computer system of at least one of the collaborating companies includes a fourth editing system for:

retrieving the exchange package;

adding problem reporting data relating to at least one entity of the technical product data in the retrieved exchange package, forming an extended exchange package; and

providing the extended exchange package to at least one computer system of a collaborating company.

In this way, problem reporting data is incorporated into the same package enabling partners to observe that a problem has been reported and to which entity it relates.

According to the measure of the dependent claim 9, the editing system is operative to incorporate the representation of the added technical product data and/or modified and/or removed technical product data in the form of a delta description that covers changes with respect to technical product data elements in a previously exchanged exchange package. In particular if the changes are small, this will keep the size increase due to the change limited. Partners can more easily spot the change, while by applying the change to a full previous version in the package they can still easily retrieve the full updated version.

According to the measure of the dependent claim 10, the data exchange package includes a header and optional attachments for representing technical product data in a data management system specific format, such as a specific CAD format. For example, CAD resource files, software designs, circuit board layouts, etc. may all be attached in the format as used by the partners involved in that aspect. Clearly, a conversion may be required if partners involved in a same aspect (e.g. designing a mechanical part using a CAD system and manufacturing the part using a CAM system) do not using the same internal format. In practice, such partners can usually agree on a commonly supported format that one system can export and the other system can import. In the system according to the invention, the technical product data in the agreed common format can be included in the exchange package as attachments. The editing system need not, but may be able to, fully interpret the format. If so desired, the editing system may perform import/export conversion where no common format can be agreed between partners.

According to the measure of the dependent claim 11, the technical product data in the exchange package is arranged in a plurality of entities, and the exchange package includes for each of the entities information on one of the collaborating companies that has ownership of the entity; the editing system being operative to, under control of a user, trigger transfer of the ownership for a user-selectable entity in the exchange package to another one of the collaborating companies. In this way responsibility can change between companies without any need for a full copying of product management system from one company to another. Such a transfer may, for example, occur during the life cycle of a product, e.g. responsibility is passed on from a manufacturing company to a service company. A transfer may also occur when a company divests its interest in a product to another company. Ownership can be separately transferred for each entity. In this way, different companies can be responsible for different parts and ownership can flexibly transferred (e.g. ownership can temporarily transferred to a sub-contractor). Preferably, transfer of ownership is effected by including in metadata of the header of the exchange package an indication of a current owner, an indication of a desired owner, and an indication of a date of transfer of ownership to the desired owner.

According to the measure of the dependent claim 13, metadata in the header includes status information on sub-projects of the project; and the editing system is operative to convert status information imported from a data management system in a data management specific format to a predetermined format. In this way, the conventional data management systems can keep their own way of indicating status and companies do not need to change the internal way of working, while for a good understanding between the partners a common status is used.

According to the measure of the dependent claim 14, metadata in the header includes information representing a relationship between attachments. Each of the data management system may already have a large number of files, with sometimes complex inherent relationships. Simply copying those files from diverse data managements systems into one package would make the content very difficult to understand for a partner. Therefore, additional information in the package indicates the structure/relationships between the documents.

According to the measure of the dependent claim 15, metadata in the header includes information on a task of the collaborating companies, such as a developer task, manufacturer task, supplier or maintenance task. For projects involving many companies, and in particular involving a hierarchy of several layers of companies, relationships and related responsibilities may be unclear. By explicitly adding task information in the exchange package, such problems are avoided.

According to the measure of the dependent claim 16, the header is in the XML format. This enables a company that does not have a dedicated editor to still observe and retrieve data from the exchange package, for example using a conventional web browser that has opened the package locally.

To meet an object of the invention, an editing system including means for:

importing technical product data relating to a user-selectable project from a plurality of distinct data management systems, such as CAD, PLM, ERP, each for creating respective technical product data;

creating an exchange package representing user-selectable parts of the imported technical product data; and

providing the exchange package to a computer system located at at least one of the other collaborating companies.

To meet an object of the invention, a method of exchanging technical product data between respective computer systems of a plurality of collaborating companies includes:

importing technical product data relating to a user-selectable project from a plurality of distinct data management systems , such as CAD, PLM, ERP, each for creating respective technical product data;

creating an exchange package representing user-selectable parts of the imported technical product data; and

providing the exchange package to a computer system located at at least one of the other collaborating companies.

To meet an object of the invention, a computer program product is operative to cause a processor to execute the steps of the method.

These and other aspects of the invention are apparent from and will be elucidated, by way of a non-limitative example, with reference to the embodiments described hereinafter.

### BRIEF DESCRIPTION OF THE DRAWINGS

In the drawings:

FIG. 1 illustrates world-wide collaboration between companies;

FIG. 2 shows product data exchange between collaborating companies;

FIG. 3 shows a block diagram of a system according to the invention;

FIG. 4 shows using a delta package for product data exchange;

FIG. 5 shows a further use of a delta package;

FIG. 6 shows a structure of a product data exchange package;

FIG. 7 shows an exemplary package;

FIG. 8 shows transfer of ownership; and

FIG. 9 illustrates problem reporting.

### DETAILED DESCRIPTION OF THE PREFERRED EMBODIMENT

FIG. 1 shows an example of a project with many collaborating companies. The project may be the development and manufacturing of a product, such as a consumer electronics product. The project may also include maintenance/servicing of a product, in particular of a professional product. The project can thus cover the entire product lifecycle (i.e. from conceptual design to product obsolescence). If so desired, in an actual application the project may be limited to only part of the lifecycle. The exchange system according to the invention covers the exchange of technical product data. In principle, the technical product data covers all technical disciplines (e.g. software, mechanics, electronics). It will be appreciated that in certain applications not all disciplines may be involved. Technical product data is exchanged using a product data exchange package. In the description here this package is limited to technical product data only. For the exchange of operational data between companies (e.g. pricing, ordering, invoicing and payment information) other e-commerce and b2b-commerce standards and exchange mechanism apply. It will be appreciated that in a practical application also operational data may be incorporated in the exchange package according to the invention. In the example of FIG. 1, the main innovation (e.g. research/development) of a new product takes place at three sites. The innovation centers are indicated as IN1, IN2 and IN3. Other types of collaborating companies indicated in the figure are: IC suppliers ICS, mechanical component suppliers MCS, electrical component suppliers ECS, chemical suppliers CS, module/sub-assembly suppliers MS, contract manufacturers CM and factories FACT of the project owner. It will be appreciated that in an actual project, certain of these roles need not be present. Also, some of these roles may be performed by more than one collaborating company. For example, four different mechanical component suppliers may be involved, e.g. each supplying a different component or acting as a second source.

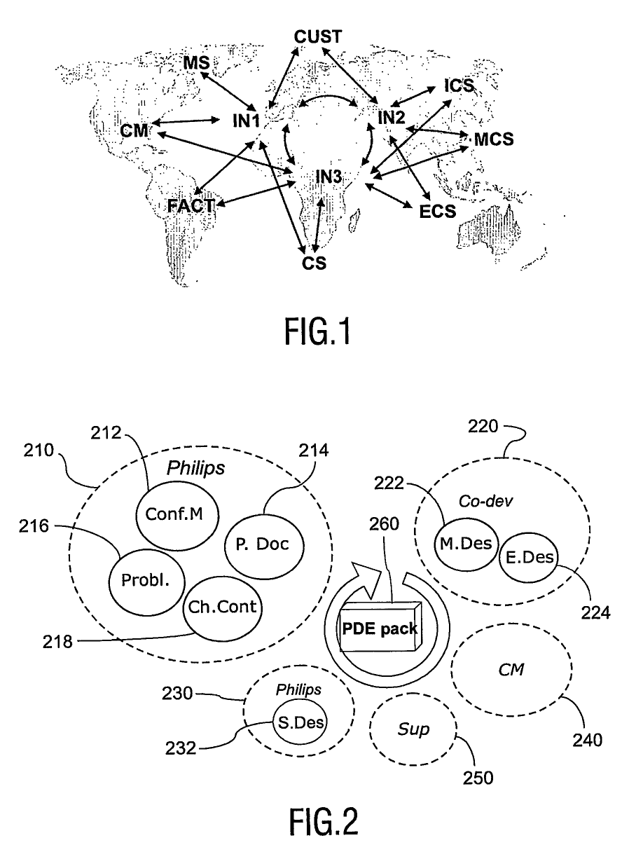

It will be appreciated that two collaborating companies may in fact be part of a same mother company. For example, a consumer electronics (CE) producing company may be owned by a mother company that also own an IC producing company that is a co-developer and/or supplier to the CE company. FIG. 2 shows a further example of a collaborating on a project. In this example, five collaborating companies are involved, 210, 220, 230, 240 and 250. In this example, company 210 is the leading company. It performs the leading roles of configuration management 212, product document management 214, problem reporting 216 and change control 218. An outside company 220 is leading for the mechanical design 222 and electrical design 224. An organization 230, that is internal to company 210 or owned by a same mother company, is leading for the software development 232. Company 240 is a contract manufacturer, and company 250 is an IC supplier. The product data exchange package 260 ensures that the companies work optimally together.

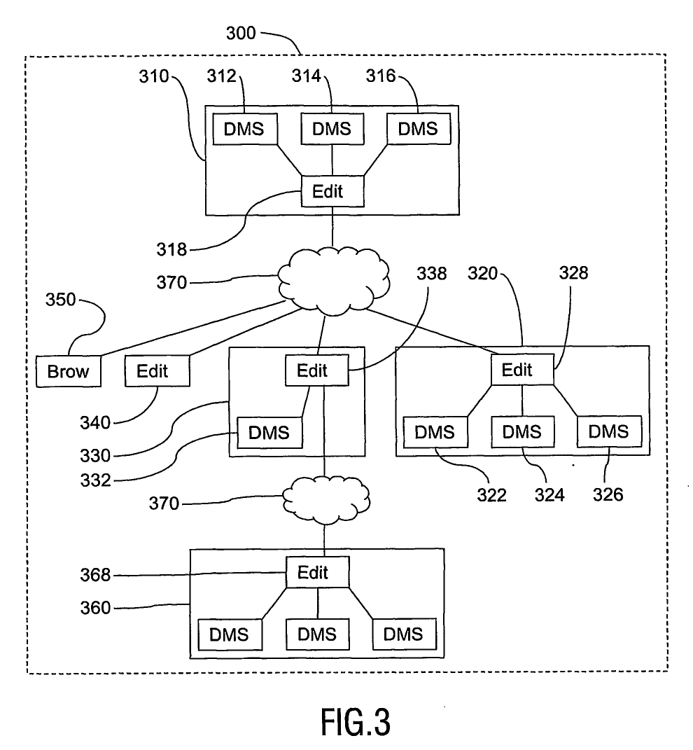

FIG. 3 shows a block diagram of the product exchange system 300 according to the invention. In this example, six computer system 310, 320, 330, 340, 350 and 360 are shown, each located at a respective collaborating company. In principle such a computer system of a company may all be located at a same site, but they may also be geographically more distributed. At least one of the computer systems includes a plurality of distinct data management systems. For example, computer system 310 includes three distinct data management systems 312, 314, and 316. In this context with ‘distinct’ is meant that the data management system perform a different role, such as CAD (Computer Aided Design), PLM (Product Lifecycle Management), ERP Enterprise Resource Planning), CAM (Computer Aided Manufacturing) and/or that they perform a same role but are of a different make in the sense that data is not freely exchangeable between the systems. Each of the data management system is used for creating respective technical product data. Persons skilled in the art know such systems and know the technical product data present in such data management systems. For example, a CAD system may supply title block data, part list data and resource files; a PLM system may supply technical specifications and configuration management; and an ERP system may supply article master data and parts list. In the remainder of the description, such data management system (DMS) will also be referred to as Product Data Management (PDM) systems. Each of those PDM systems may perform a role of archiving part of the created technical product data, whereas some of the data itself may have been created on another system, like a CAD workstation (not shown in the FIG. 3). The technical product data is used for the manufacturing of a working product This not only covers electrical, mechanical or chemical aspects but also embedded software controlling the operation of the product or performing technical functional aspects of the product. The computer system 310 also includes an editing system 318 that is able to import technical product data relating to a user-selectable project from a plurality of the data management systems 312, 314, and 316. Since each of the PDM systems is typically used for several projects in parallel (or sequential), the editing system 318 enables the user to select one of the projects and automatically collect the data for the project from a plurality of the systems. The editing system 318 may need to store additional data, e.g. on a hard disc, to be able to do this. Such data may, for example, map an identification of a user selectable project to information that enables the editing system 318 to retrieve the relevant data from the PDM systems. Such information may be a project identification used in the PDM system or simply a list of files names in the PDM system. As an alternative to selecting the project in the editing system 318, the user may select the project in each respective data management system. The editing system 318 may perform the importing in any suitable way. For example, the editing system may have knowledge of the data model used by the PDM system and use this knowledge to retrieve the data directly from the PDM system (e.g. from the PDM system's database). The PDM system may also have exported relevant data in a format that can be imported by the editing system 318. The editing system 318 may need to perform a conversion of a format of the imported technical data. As will be described in more detail below, the editing system preferably adds metadata into the exchange package in a format interpretable by all collaborating companies. Part of the metadata distinct data management systems may need to be retrieved form the imported technical data and thus may involve a format conversion. The editing system 318 creates an exchange package representing user-selectable parts of the imported technical product data. Thus, the editing system 318 enables a user to select which imported technical data needs to be represented and which should not be represented. The selection may, for example, be targeted towards a specific collaborating company, e.g. a mechanical part supplier needs no data relevant for software development and vice versa. Similarly, CAD files may include some data relevant for the internal working within a company but irrelevant for a supplier. The representation of the technical data may take any suitable form, including a direct copy or a conversion. The editing system 318 provides the exchange package to a computer system located at at least one of the other collaborating companies. It may, but need not, supply it to all collaborating companies. As indicated it may also supply a company-specific package to one company only. Since the package can be very large (e.g. 500 Mbytes) the package is supplied ‘off-line’. Preferably, the package is still supplied via a computer network 370. This may be a direct/hired link, but preferably a broadband Internet connection is used. Suitable internet protocols are HTTP/SOAP, FTP or email. If so desired, the package may also be supplied on a record carrier, such as a CD-R/RW or DVD+R/RW. Preferably, the package is protected against undesired operations of competitors by securely providing the package (e.g. using SSL within Internet or conventional encryption techniques for distribution via record carriers).

The editing system may be implemented in any suitable way. Typically, it is implemented on conventional computer, such as a PC or workstation, where the functionality of the editing system is performed by the processor (not shown) under control of a suitable program. The program may be loaded form a background storage (not shown), such as a hard disc, or even ROM, into the processor or a working memory, such as the main RAM of the computer. The user can control the editing system 318 via any suitable user interface (not shown), such as a keyboard/mouse for input and a display/printer for output. In particular, in an embodiment, the editing system lets a user to perform at least one of the following control operations:
add technical product data into the exchange package;
remove a user-selectable part of the imported technical product data;
modify a user-selectable part of the imported technical product data.

For example, a user may add technical product data that is not present in the PDM system or can not be exported in a format that can be imported by the editing system 318. A user may remove parts of the technical data, e.g. data that is irrelevant for the collaborating company to which the package is sent. The user may also modify a user-selectable part of the data, e.g. to reflect recent changes not yet effectuated in the PDM system.

In an embodiment of the invention, a computer system 320 of at least one of the collaborating companies includes a further data management system 322 for operating on technical product data. In the example of FIG. 3, the computer system 320 in fact includes three different PDM systems 322, 324 and 326. The computer system 320 includes a second editing system 328 for retrieving the exchange package. The editing system 328 exports user-selectable technical product data from the exchange package to the further data management system 322. It may also export technical product data to the other PDM systems 324 and 326. The user can control which data in the package is exported. Analogous to the importing described for the editing system 318, editing system 328 may export data by directly accessing a database of the PDM system. If there is more than one PDM system, preferably, the editing system 328 enables the user to specify to which PDM system the selected data should be exported. The data may also be exported as files and loaded into the PDM via a conventional import function of the PDM system. The editing system 328 may need data that enables it to relate the data in the package to corresponding data in the PDM system. The exporting by the editing system 328 may also include data conversion. The editing system 328 may be combined with the editing system 318 in a multi-functional editing system that can import from PDM systems and export to PDM systems. If so desired, a collaborating company may be supplied with a limited functionality editing system, e.g. enabling a company to retrieve packages but not to create packages.

In an embodiment according to the invention, a computer system 330 of at least one of the collaborating companies includes a third editing system 338. In the example of FIG. 3 it also includes a PDM system 332, but this is not required. The editing system 338 retrieves the exchange package. Under control of a user, the editing system 338 represents user-selectable parts of technical product data in the retrieved exchange package into a further exchange package. It provides the further exchange package to a computer system 360 located at at least one sub-contractor of the collaborating company. This collaborating company may, for example, be a sub-contractor of the company with system 330. In this way complex relationships between collaborating companies can be created in a simple way. As before, this editing system 338 may but need not be combined with other functionality such as described for editing system 318 and 328. The company with computer system 360 may, but need not, have an editing system 368 and data management systems.

It will be appreciated that user-control of an editing system can be automated. For example, a user may once perform a certain task (e.g. selection of data imported form the PDM systems that needs to be represented in the package) and the editing system may be able to repeat this task at a later moment, similar to recording a macro and executed it again later on. A user may also ‘program’ the user control task into the editing system, e.g. using scripting.

FIG. 3 illustrates a further use of an editing system 340. In this case, the computer system of a collaborating company does not include a PDM system into which technical product data can be exported by the editing system or from which technical product data can be imported. Instead, the user can use the editing system to retrieve the exchange package, view the content of the exchange package and store selected parts in a storage system, such as a hard disc for further operations and/or print the selected parts of the technical product data.

In an embodiment, the data exchange package includes a header and optional attachments for representing technical product data in a data management system specific format, such as a specific CAD format. Preferably, wherein the header is in the XML format. The header may include metadata as will be described in more detail below. Using XML enables a collaborating company to view the package using a conventional internet browser, such as Microsoft's Internet Explorer. This is illustrated for computer system 350 that only includes a browser. With the browser the user of the system can select parts of the package and store and/or print them. The selected parts can thus also be imported in PDM systems. In an embodiment, the package according to the invention is based on an existing, open data exchange standard. In particular, the package may be based on the Nemi/IPC Product Data eXchange (PDX) standard for electronics manufacturing supply chain communication, IPC-257-Series, where additional functionality according to the invention can be achieved by extension to this standard. Certain attributes in an exemplary package definition may be the same as in the IPC-257-Series. Those attributes will not be defined in full here. The attribute definitions of this standard are hereby included by reference.

Baselines and Delta Packages

In an embodiment, a product data exchange package contains a baseline or the set of latest information of the project. A baseline is a consistent set of product information. The various versions and revisions of the technical product data in the baseline are preferably consistent with each other. The package contains only one specific revision or version of technical product data. Multiple revisions or versions of technical product data is preferably not represented in the same package, since it will not be clear to the receiver which revision is the proper one to use. An exception is the use of delta packages, as will be described in more detail below. An issuer of the package (i.e. the user controlling the editing system 318) may issue a same baseline package to all collaborating companies. This may, for example, be useful at the start of a project, where most information in the package is global. The issuer may also issue packages targeted at the recipient, i.e. containing only the selection of the technical project data in the project that is relevant for the recipient. For example, a manufacturer of a specific mechanical part only needs to obtain data relevant for the production of that part.

Once packages with product information have been distributed, the original information at the owning site may change. Preferably, changes are not communicated immediately. Instead, the preferred approach is to collect product information in such a way in the package that the receiver can work with this information without having to know all intermediate changes that the owner made. For example, in a software development process an owner distributes version “0.3” for testing purposes to a partner. In the meantime, the software developer continues his work (and a version “0.4” and “0.5” are created) without distributing these updates to the partner. Finally, after having received the partner's test results and having incorporated these in the software, the owner distributes version “0.6” since this is the next release that is of interest to the partner. Thus, the intermediate steps made by the owner that led from the original information to the new information need not be communicated.

For distributing the changes that have occurred in a period of time, the data exchange system according to the invention supports at least one of the following two approaches:
Distribute a new product data exchange package with the new baseline of information, i.e. the relevant technical product data is represented in full in the package itself
Distribute a product data exchange package with the ‘delta’, i.e. only the information that has been changed since the last time that a package was sent. If so desired the ‘delta’ may also be defined to an earlier package than the immediately preceding package. In this case, it is preferred that an identification (such as a package name and date) is included in the delta package. The receiver can use the delta package to update his local information to the new baseline of information.

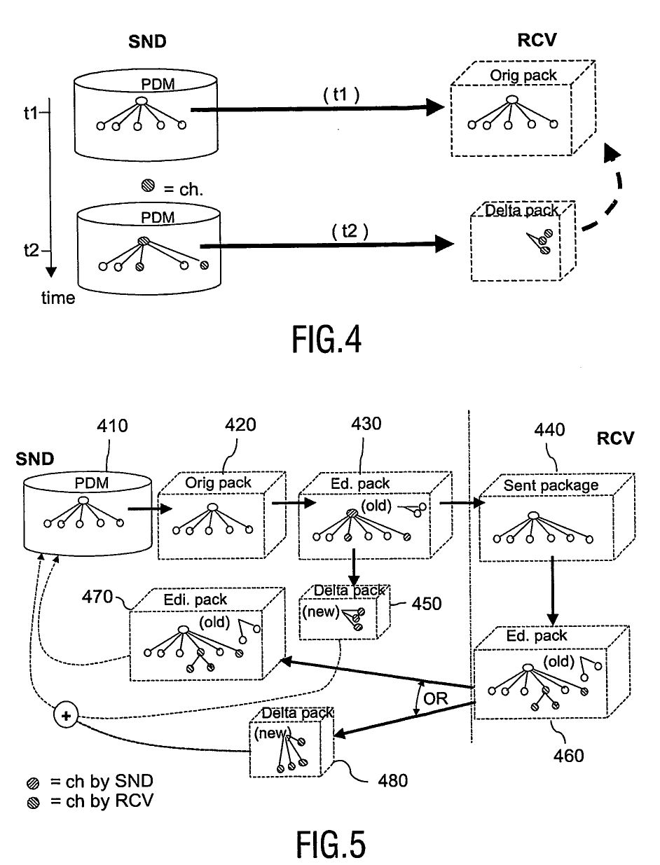

The concept of delta packages is further illustrated in FIGS. 4 and 5. In FIG. 4 the relevant product data at time t1 is represented in an exchange package sent from sender SND to the receiver RCV. At time t2 changes indicated using a hatched pattern ch are effected in the product data. A delta packages only representing the changes is sent from SND to RCV. The delta package refers back to the original package. In FIG. 5, product data from a PDM system is supplied as a package 420 to an editing system. The editing system, under control of a user, adds an item and changes an item, also affecting the root element of the package. A package 430 is created still including the changed and added item, for traceability. The package 430 is supplied to a receiver RCV. An editing system at the receiver RCV is used add further items, resulting in a package 460. At the choice of the receiver, the entire updated package 460 may be supplied as package 470 to the original sender SND or a delta package 480 reflecting the changes made by the receiver RCV may be sent. The entire package 470 reflecting changes in package 430 and 460 may be fed back into the PDM system 410. Alternatively, the delta package 480 may be combined with a delta package 450 that reflects changes made in package 430. The combined set of changes is then imported into the PDM system 410.

Delta packages can be handled using the following attributes on the elements in the package:

| Name | description |
|---|---|
| deltaEditStatus | Indicator whether the element, or its |
| | sub-elements and attributes have |
| | been changed or added to the package. |
| deltaOldItemUniqueIdentifier | Pointer to the unique identifier |
| | of the old element that has been compied |
| | to the “deltaOld” section of the package. |

Package Structure

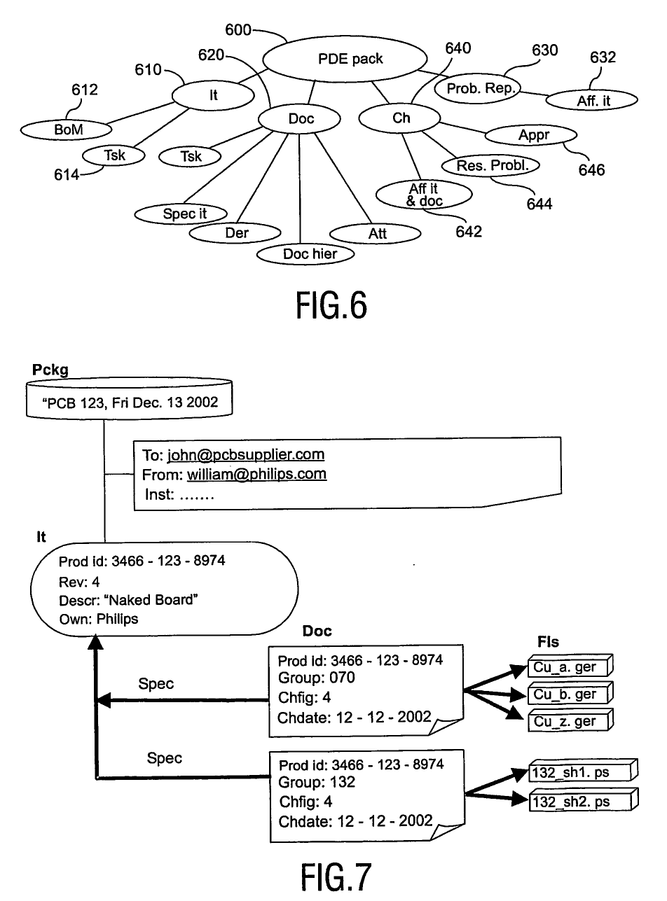

FIG. 6 gives an overview of the following main elements that may be present in the product data exchange package 600:
Items 610 represent uniquely identified entities that an organization uses to manage its product information, such as an (end) product, module, (phantom) assembly, part or component. During its lifecycle, multiple revisions and versions may be created and maintained. Items mainly represent tangible parts of the product. An item may also represent embedded software or an embedded software module. Associated with the items are their respective characteristics, single-level bill of material 612 and task information 614 for co-developers, manufacturers, suppliers and maintainers/service providers of the item.
Documents 620 represent business documents that contain detailed product information related to one or more items captured in a file. Examples are: technical specifications, design sources files, drawing files, manufacturing files, project files, quality documents, requirement specifications and project reports. Documents can have their own document structure. Furthermore, associated with the documents are their respective attributes, file and application information, and their relations with items. During its lifecycle, multiple revisions and versions may be created and maintained.
Problem reports 630 are used for the communication of field problems, enhancement requests, etc. A problem report contains information on the problem originator, the problem owner, problem details, and the resolution status of the problem. Problem reports are associated with the items 632 that are affected by the problem.
Changes 640 represent change requests, change orders and change notifications.

Examples of changes are: engineering changes, part list changes. Changes are associated with the affected documents and items. Furthermore, they are associated with the problem reports 644 that they resolve and the party 646 approving the change.

Traditionally, the exchange of source data from multiple design authoring systems (e.g. MCAD, ECAD and CASE tools) between heterogeneous design data management systems (e.g. CAD-PDM databases and file servers) was problematic due to:
Complex interrelations between source files
Management of file versions and revisions
The source is used for the generation of derived data files (such as drawings in plotting formats and 3D-viewing files). The interrelations between derived files and the original source data must be maintained.
Design structures are often partly matching with product structure configuration information, but almost never completely match.

This complexity is not addressed in state of the art open product data exchange standards where files are implemented as simple attachments without relations to other attachments. For an effective exchange of technical product data structures, the exchange package incorporates structures in at least one of the following ways:
Design source files (files in the proprietary format of the design authoring tool) are represented as a special type of Documents: Design Source Documents. This is implemented by using the ‘Document’ element's attribute ‘designSourceDocument’ in the package. This attribute is set to “yes” for a Design Source Document and to “no” for all other types of documents.
Derived files (files generated from the source design, but in a format that is supported by multiple applications e.g. for viewing, printing and manufacturing purposes) are represented as Documents.
Each Document and Design Source Document has its own revision and version indicator, represented by attributes in the package.
Each Design Source Document has at least one of the following information from the originating design authoring environment:
   Application name
   Application version
   (Relative) path info of the file location
‘BillOfDocumentsItem’ relations between the design source documents describe the hierarchy of the source design: i.e. which source files need which other source files in order to process them in the design authoring tool.
‘DerivedFromFile’ relations between the design source documents and the documents describe from which source design files a document was derived.
‘SpecifiesItem’ relations between items and design source documents/documents describe on which item the related document contains detailed information
The Design Source Documents that are in a package on the top of a design hierarchy contain information on the configuration of underlying versions and revisions.

An example of a package Pckg is illustrated in FIG. 7. It contains sender information (From: . . . ), receiver information (To: . . . ) and an optional instruction/comment field (Inst:), like “Here are the specifications for our board”. This package contains one item It, with a product identifier (Prod id), a revision number (Rev), a description (Desc), and an Owner (Own). The item is further specified by two documents Doc, each with there own respective fileds and attached files (Fls).

Ownership

Product data exchange leads to the situation that copies of technical product data are distributed to multiple locations. It is preferred that it is known where the original master of the information is kept. In an embodiment, the product data exchange package incorporates this information by assigning owners to the main elements in the package. The owner is the person or organization that keeps and maintains the master of distributed product information. Preferably, in the product data exchange package owners are assigned to items, documents, changes and problem reports.

The owner of an item is preferably the owner of all underlying elements including:
The item's characteristics and attributes
The (single-level) bill of materials. Note that the items occurring on the bill of materials may have their own owners.
The task information associated to the item.

The owner of a document is preferably the owner of all underlying elements including:
The document's characteristics and attributes
File and attachment information
The (single-level) bill of documents. Note that the documents occurring on the bill of documents may have their own owners.
The developer task information that is directly associated to the document.
The links to items (by means of the ‘specifies item’ element.)
The links to derived files (by means of the ‘derived from file’ element.)

The owner of a change is preferably the owner of all underlying elements including:
The links to affected items and documents (by means of the ‘affected item’ and ‘affected document’ elements.)
The links to the resolved problem reports (by means of the ‘resolved problem’ elements.)

The owner of a problem report is preferably the owner of all underlying elements including the links to affected items (by means of the ‘affected items’ element.)

The ownership information allows that product information from multiple owners is communicated in a single product data exchange package. Preferably, the owner of the information is responsible for the distribution of the changes. This is illustrated in the figure below. Note that during the collaboration with partners the ownership of product information may shift from one site to another. When the ownership shifts, the new owner will also become responsible for distributing the changes that he makes on the information.

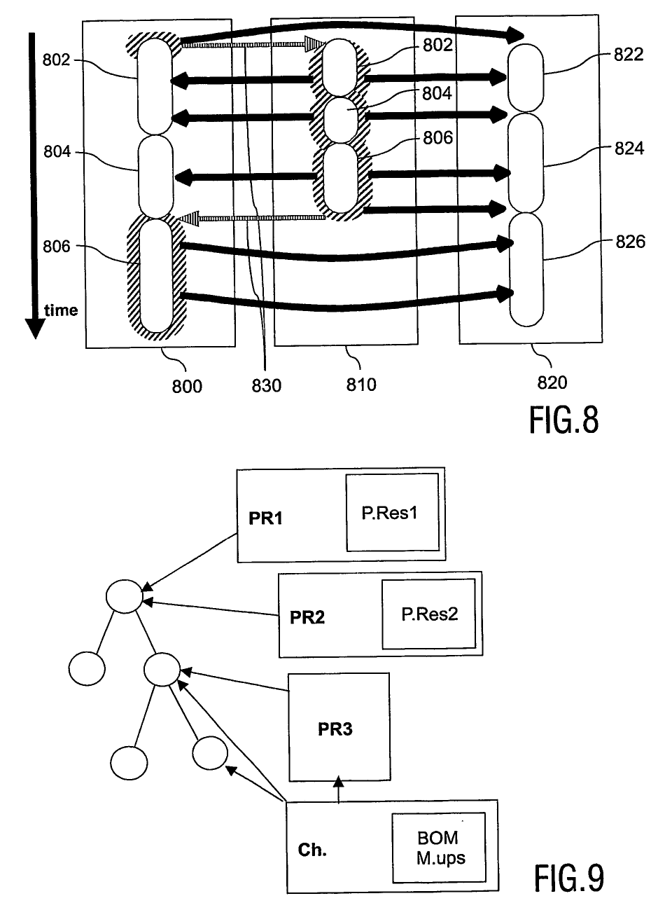

During the collaboration with partners the ownership of product information may shift from one site to another. An example scenario is given in the FIG. 8. In this example, an OEM 800 defines a module. States within the OEM 800 may be system development 802, pre-production 804, and mass production 806. The OEM outsources the module's engineering to a module developer 810 and its pilot production to a contract manufacturer 820. The module developer will become the owner of the corresponding product information. After the transfer, the module developer is responsible for the master information of the module and for the distribution of updates due to changes to the OEM and the contract manufacturer. After the pilot production phase, the ownership will be transferred back to the OEM that takes over responsibility for the module Transfer of ownership is indicated with arrows 830. The other arrows indicated the distribution of module product data. The module developer 810 may have as main states module development 812, samples 814, and pilot production 816. The hatching indicates ownership in the figure.

In an embodiment of the system according to the invention, to communicate the transfer of ownership, the following information is added in the product data exchange package to the items and/or documents that will be transferred in addition to the current information defined in IPC standard:
The new owner’, by means of the attribute ‘transfer owner to contact unique identifier’

The date at which the transfer of ownership becomes effective, by means of the attribute ‘transfer owner date’.

| name | description |
|---|---|
| transferOwnerToContactUniqueIdentifier | Pointer to the contact element |
| | that contains information |
| | about the site that will take |
| | over ownership for the item |
| transferOwnerDate | Date on which the transfer |
| | of ownership has been agreed |
| | to become effective |

By transferring ownership, both partners preferably agree that:
The sender will treat the product information for which the ownership was transferred as product information owned by the other site
The receiver will become the owner of the master information and distribute updates due to changes.
   Problem Reporting

It is desired that the communication of problems (e.g. enhancement requests, field problems) over the development and supply chain is established as early as possible in order to allow all business partners to properly respond, communicate and implement solutions. In an embodiment according to the invention, problem reports can be created and incorporated in the exchange package. Preferably, everyone in the chain can create a problem report. The creator of the problem report is called the problem originator. The originator is not necessary the ‘problem owner’. Depending on the cooperation model between the partners, it may be decided to whom the originator shall address the problem reports. For example, problem reports may be collected and managed centrally by the OEM, or a distributed model may be agreed in which problem reports are submitted directly to the respective owner of the affected modules. The person or organisation that is assigned to solve the problem will become the problem owner. The problem owner is responsible for handling the problem. Furthermore, the problem owner is responsible for communicating the problem resolution and status to the partners. This is further illustrated in FIG. 9. In this FIG. 2 two problems reports PR1 and PR2 have already been closed and the respective problem resolutions P.Res1 and P.Res2 are included. Problem report PR3 has requested a change, but the proposed change CH with the Bill of Material (BOM) Markups not yet been approved. The communication of problems is preferably effected in the following way:
A problem report can be distributed by everyone in the development or manufacturing chain. The problem report contains a description of the problem, attachments for details and contact information from the originator of the problem report
The problem report must always be associated with one or more affected items.
Each problem report gets a problem owner. The problem owner is responsible for handling the problem. Different responses are possible:
   Change the status of the problem report
   Attach resolution information directly to the problem and communicate the resolution across business partners
   Initiate Changes that are required to resolve one or more problems. And communicate the changes for informing business partners, for review/validation/approval by business partners
A change describes the change request/change order/change note information including:
   Links to the problems that are resolved in the change
   Links to the affected items

Problem reports in the exchange package can be handled by defining an entity ‘ProblemReport’. The following table specifies the possible attributes for an embodiment of the ‘Problem Report’ entity in an open product data exchange standard:

| Attribute name | Description |
|---|---|
| problemReportIndentifier | Identification number of the problem as |
| | displayed |
| problemReportUniqueIdentifier | Unique number within package to identify the |
| | problem report |
| problemOriginatedByName | Originator of the problem. Only used if the |
| | corresponding Contact element is not included |
| | in the package. We recommend not using the |
| | name of an individual person but the name of |
| | the responsible organization and its location. |
| problemOriginatedByContactUniqueIdentifier | Pointer to the Contact element with detailed |
| | contact information. Only used if the |
| | corresponding Contact element is included in |
| | the package. |
| globalEngineeringProblemStatusCode | Status code for the problem report. |
| globalEngineeringProblemStatusCode | A more descriptive value for the problem |
| Other | status. The attribute |
| | globalEngineeringProblemStatusCode must be |
| | set to “Other” |
| problemStatusDate | Date the status was modified |
| problemOwnerName | Problem owner for resolving the problem. Only |
| | used if the corresponding Contact element is |
| | not included in the package. We recommend |
| | using not the name of an individual person, but |
| | the name of the responsible organization and its |
| | location. |
| problemOwnerContactUniqueIdentifier | Pointer to the Contact element with detailed |
| | contact information. Only used if the |
| | corresponding Contact element is included in |
| | the package. |
| description | Description of the problem. (Note that a |
| | detailed description of the problem can be |
| | included as an attachment.) |
| problemType | Type of problem (EnhancementRequest, |
| | FieldProblem, etc.) |
| problemSubType | Subclass of problem |
| problemPriority | Indication of priority, importance, significance |
| | and urgency of the problem |
| problemOriginationDate | Date and time the problem was originated |
| problemResolutionDescription | Description of the resolution or workaround of |
| | the problem |

The ‘AffectedItems’ and ‘AffectedItem’ elements are used to relate the ProblemReport to Items.

Process Status

In an embodiment according to the invention, the system supports that the partners using product data exchange in their collaborative development and supply chain communication can follow their own internal processes. This is also illustrated in the FIG. 8. The cooperation model between the partners will define what information will be exchanged during which phases and milestones, so that each partner will have the necessary inputs at the right moments. The package enables a partner to use in the exchange its internal identification codes for products and documents. In the package, the different codes used for the same product or document can be related. To indicate the lifecycle status of products and documents (e.g. ‘Draft, ‘Released for Production’, etc.) the owner has two options:
Map the owner's internal states to a predefined list of states, so that the sender and receiver can use the same language to indicate the maturity of exchanged information.
Include the state at the owner's site directly in the package.

Furthermore, the status of a (sub-)project, indicating the status of an activity at the owner's site, may be represented in the package in a similar way. The predetermined list of states has a defined same meaning for all collaborating companies. In an embodiment, the editing system is able to convert internal states (e.g. defined by a PDM system or defined within one of the collaborating companies) to the predetermined states. To this end, a user may define a conversion table in the editing systems so that the editing system can perform the conversion automatically. Since a conversion may not be perfect, preferably the editing system at a receiving site makes status information from the owner visible by means of an additional field. This field may also be exported to the PDM system in addition to the local state information. In most cases, it won't make sense to map the status information from the sender to the lifecycle process of the receiver because sender and receiver will follow different processes.

Task Information

In an embodiment, the tasks that have to be executed with distributed product data are communicated in the product data exchange package. The purpose of communicating this information is that every partner can be informed on the responsibilities of the other partners. The task information can be used for:
Setting up a “work breakdown” structure that enables business partners to exchange product development data within the context of their tasks in the work breakdown.
Problem reporting and change handling in the extended enterprise. The task information shows who is responsible for tasks to which the related product information is critical. Therefore, we recommend keeping all parties that are assigned with a task updated on the problem reports and changes for the related product.
Splitting up data packages into pieces that must be further distributed downstream and upwards the supply chain.

The following four different types of tasks may be distinguished:
Developer task: The task for developing and engineering a product (module) and the maintenance of the development data.
Manufacturer task: The task for manufacturing or assembling a product (module) according to specifications. Sub-modules of the assigned module can be outsourced to other manufacturers.
Supplier task: The task for supplying a product (module). Supplier tasks are assigned if the manufacturer and the supplier are not the same contact. For example, a capacitor may be manufactured by Philips and supplied by a retailer.
Service/maintenance task: The task for servicing/maintaining the product (module) once it has been supplied to a customer.

A preferred way of exchanging task information is the following:
At the start, all partners will be informed on their own and the other partners' task information. This is achieved by distributing a product data exchange package containing the main modules of the product and their respective development, manufacturing, supplier, service/maintenance tasks.
The partners in the chain will use the distributed ‘work breakdown structure’ for determining which other partners must receive their product information. Furthermore, the task information is included in product data exchange packages to enable their breaking up and further distribution to (sub)contractors in the supply chain.
When changes occur in the task information, for example the list of preferred manufacturers for an item is narrowed down to one preferred manufacturer, the owner of the corresponding item is responsible for communicating these task changes to the other partners. In principle, all partners should be notified on changes in the tasks.

By means of the owner information, the receiver of the package will be able to locate the responsible party for the information.

In an embodiment of the invention, task information is incorporated into the package using the ‘ApprovedManufacturerList’ and ‘ApprovedSupplierList’ elements from the IPC-2578 standard and adding:
Element ‘ApprovedDeveloperList’
Element ‘DeveloperPart’

And defining an additional attribute ‘taskInstructions’.

Details of a Delta Package

The delta package may contain all modified Items, Documents, Changes, ProblemReports, and their underlying elements, depending entities (e.g. task information) and attributes. Note that if only a single attribute field of, for example, an Item has changed, then the complete Item element with all underlying elements and attributes will be exchanged in the delta package.

A delta package can be created by defining a new entity ‘Delta’. The Delta entity has two underlying elements: ‘DeltaNew’ and ‘DeltaOld’. A ‘DeltaNew’ element contains the changed Items, Documents, Changes, etc. The receiver can use these elements to update previously received information. A ‘DeltaOld’ element contains the original Items, Documents, Changes, etc. that have in the meantime been changed. For exchanging delta packages, this element is optional. (Since the receiver will already have this information.) The main purpose of the element is for traceability, which is described in more detail below.

The table below specifies possible attributes of the ‘DeltaOld’ and ‘DeltaNew’ elements for an embodiment in an open product data exchange standard:

| Attribute name | Description |
|---|---|
| originalpackageDocumentIdentifier | Identification number of the |
| | original package (attribute |
| | “thisDocumentIdentifier”) to |
| | which the Delta relates. |
| originalPackageDocumentGenerationDateTime | Origination date of the original package |
| deltaPackageDocumentGenerationDateTime | Date to which the updated |
| | information is actual |

Traceability

As product content moves through the extended enterprise, the control over changes in information due to manual update processes may be lost. Issues that must be addressed are:
After selection and download from the PDM system of the sender product data may be changed in the editing system before the package is sent
After receiving the package the receiver may change the package contents using its editing system

In certain environments and under certain co-operation models it may be required that all changes must be traceable. To meet traceability requirements, it is preferred to keep track of the following information:
The export queries used for extracting the product data from the product data base into the package
The changes that were made on the package using the editing systems

The traceability information can be used in the following ways:
The traceability information can be kept by the sender and used for registering sent packages without having to keep a copy of the sent package.
The traceability information can be incorporated into the package. The receiver of the package can see (in an editor) what changes were made before the package was sent.

The traceability data includes:
for added technical products data: a representation of the added technical product data;
for removed technical product data: a representation of the removed technical product data; and
for modified technical product data: a representation of both the original and modified technical product data.

This can be done by using the ‘Delta’ elements that have been described above. When an item, document, change, problem report, contact, manufacturer part, supplier part or develop part in the package is being modified for the first time, then the original element is preferably copied to the ‘DeltaOld’ element in the package. After the original information has been secured in this way, the element in the package can be edited. The ‘DeltaOld’ element will thus contain all originals and their underlying elements and attributes. If an element is edited, then this can be indicated by the additionalAttribute elements ‘deltaEditStatus’ (it will receive the value “Edited”) and ‘deltaOldItemUniqueIdentifier’ (which will contain a pointer to the corresponding element under ‘deltaOld’). In this way only the original element and the latest edited element are stored in the package. Intermediate states, that may have occurred when the element was edited multiple times after another before sending, will not be kept If new elements are created in the package, for example a new Item is added to the product structure, or a new Document is created, then this will be indicated by the additional attribute ‘deltaEditStatus’, which will receive the value “Added”. FIG. 5 illustrates how traceability information in the package can be used. The sender creates a new package and edits this package. For traceability, he keeps the extraction data and a delta package of the edits. (So he can always re-create the package without having to keep a copy of the changed package.) Once received, the receiver will make further edits on the package. After editing, the receiver can either send the complete package (with edited and old elements), or send a delta package containing the updates. In both approaches, the edited data can be fed back to the data management system of the sender.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. The carrier be any entity or device capable of carrying the program. For example, the carrier may include a storage medium, such as a ROM, for example a CD ROM or a semiconductor ROM, or a magnetic recording medium, for example a floppy disc or hard disk. Further the carrier may be a transmissible carrier such as an electrical or optical signal which may be conveyed via electrical or optical cable or by radio or other means. When the program is embodied in such a signal, the carrier may be constituted by such cable or other device or means. Alternatively, the carrier may be an integrated circuit in which the program is embedded, the integrated circuit being adapted for performing, or for use in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A product data exchange system (300) for exchanging technical product data between respective computer systems (310, 320, 340, 350, 360) of a plurality of collaborating companies; at least a computer system (310) of a first one of the collaborating companies including:
a plurality of distinct data management systems (312, 314, 316), such as CAD, PLM, ERP, each for creating respective technical product data; and
an editing system (318) for:
importing technical product data relating to a user-selectable project from a plurality of the data management systems;
creating an exchange package representing user-selectable parts of the imported technical product data; and
providing the exchange package to a computer system located at at least one of the other collaborating companies.

2. A product data exchange system as claimed in claim 1, wherein a computer system of at least one of the collaborating companies includes:
a further data management system for operating on technical product data; and
a second editing system for:
retrieving the exchange package; and
exporting user-selectable technical product data from the exchange package to the further data management system.

3. A product data exchange system as claimed in claim 1, wherein a computer system of at least one of the collaborating companies includes a third editing system for:
retrieving the exchange package;
combining user-selectable parts of technical product data in the retrieved exchange package into a further exchange package; and
providing the further exchange package to a computer system located at at least one sub-contractor of the collaborating company.

4. A product data exchange system as claimed in claim 1, wherein the editing system is operative to enable a user to perform at least one of the following control operations:
add technical product data into the exchange package;
remove a user-selectable part of the imported technical product data;
modify a user-selectable part of the imported technical product data.

5. A product data exchange system as claimed in claim 1, wherein the editing system is operative to automatically insert traceability data into the exchange package representative of control operations of a user of the editing system.

6. A product data exchange system as claimed in claim 4, wherein the traceability data includes:
for added technical products data: a representation of the added technical product data;
for removed technical product data: a representation of the removed technical product data; and
for modified technical product data: a representation of both the original and modified technical product data.

7. A product data exchange system as claimed in claim 1, wherein the editing system is operative to import technical product data that relates to a same baseline of the project from the plurality of the data management systems.

8. A product data exchange system as claimed in claim 1, wherein a computer system of at least one of the collaborating companies includes a fourth editing system for:
retrieving the exchange package;
adding problem reporting data relating to at least one entity of the technical product data in the retrieved exchange package, forming an extended exchange package; and
providing the extended exchange package to at least one computer system of a collaborating company.

9. A product data exchange system as claimed in claim 1, wherein the editing system is operative to represent technical product data in a further exchange package in the form of a delta description that covers changes with respect to technical product data represented in a previously provided exchange package and to incorporate a reference to the previously provided exchange package in the further exchange package.

10. A product data exchange system as claimed in claim 1, wherein the data exchange package includes a header and optional attachments for representing technical product data in a data management system specific format, such as a specific CAD format.

11. A product data exchange system as claimed in claim 1, wherein the technical product data in the exchange package is arranged in a plurality of entities, and the exchange package includes for each of the entities information on one of the collaborating companies that has ownership of the entity; the editing system being operative to, under control of a user, trigger transfer of the ownership for a user-selectable entity in the exchange package to another one of the collaborating companies.

12. A product data exchange system as claimed in claim 10, wherein the editing system is operative to include in metadata of the header of the exchange package an indication of a current owner, an indication of a desired owner, and an indication of a date of transfer of ownership to the desired owner.

13. A product data exchange system as claimed in claim 10, wherein metadata in the header includes status information on sub-projects of the project; the editing system being operative to convert status information imported from a data management system in a data management specific format to a predetermined format.

14. A product data exchange system as claimed in claim 10, wherein metadata in the header includes information representing a relationship between attachments, where the relationship is one of the following:
an attachment further specifies information in a related entity;
information in an attachment is derived from information in a related attachment;
an attachment is hierarchically related to another attachment.

15. A product data exchange system as claimed in claim 10, wherein metadata in the header includes information on a task of the collaborating companies, such as a developer task, manufacturer task, supplier task, or service/maintenance task.

16. A product data exchange system as claimed in claim 10, wherein the header is in the XML format.

17. An editing system for use in the product data exchange system as claimed in claim 1 for exchanging technical product data between respective computer systems of a plurality of collaborating companies; the editing system including means for:
importing technical product data relating to a user-selectable project from a plurality of distinct data management systems, such as CAD, PLM, ERP, each for creating respective technical product data;
creating an exchange package representing user-selectable parts of the imported technical product data; and
providing the exchange package to a computer system located at at least one of the other collaborating companies.

18. A method of exchanging technical product data between respective computer systems of a plurality of collaborating companies; the method including
importing technical product data relating to a user-selectable project from a plurality of distinct data management systems , such as CAD, PLM, ERP, each for creating respective technical product data;
creating an exchange package representing user-selectable parts of the imported technical product data; and
providing the exchange package to a computer system located at at least one of the other collaborating companies.

19. A computer program product operative to cause a processor to execute the steps of the method as claimed in claim 18.
